(19) United States
(12) Patent Application Publication
(10) Pub. No.: US 2025/0348624 A1
(43) Pub. Date: Nov. 13, 2025

(54) IN-LINE MEMORY ENCRYPTION WITH POWER AWARE CACHE SYSTEM

(71) Applicant: CRYPTOGRAPHY RESEARCH, INC., San Jose, CA (US)

(72) Inventors: Walter Nestor Petters Guse, Tilburg (NL); Cezar Rodolfo Wedig Reinbrecht, Berkel-Enschot (NL); Ajay Kapoor, Eindhoven (NL)

(21) Appl. No.: 19/192,836

(22) Filed: Apr. 29, 2025

Related U.S. Application Data
(60) Provisional application No. 63/644,145, filed on May 8, 2024.

(51) Int. Cl. G06F 21/72; G06F 21/64; G06F 21/78

(52) U.S. Cl. CPC G06F 21/72; G06F 21/64; G06F 21/78

(57) ABSTRACT

Technologies for in-line memory encryption with a power-aware cache system (IME-PACS) are described. One memory encryption circuit includes cryptographic circuitry and control circuitry. Control circuitry, in a power-off process, causes the cryptographic circuitry to encrypt the plaintext data of one or more cache entries having the first persistent valid flag set to obtain ciphertext data, and stores the ciphertext data in a memory system. The control circuitry, in a power-on process, loads the ciphertext data from the memory system for the cache entries having the first persistent valid flag set, causes the cryptographic circuitry to decrypt the ciphertext data to obtain the plaintext data, and stores the plaintext data in the one or more cache entries of the first cache.

### RELATED APPLICATIONS

This application claims the benefit of U.S. Provisional Patent Application No. 63/644,145, filed May 8, 2024, the contents of which is incorporated by reference in its entirety herein.

### BACKGROUND

Modern computer systems generally include a data storage device, such as a memory component or device. The memory component may be, for example, a random-access memory (RAM) or a dynamic random-access memory (DRAM) device. The memory device includes memory banks made up of memory cells that a memory controller or memory client accesses through a command interface and a data interface within the memory device. The memory devices can be located on a memory module. The memory module can include one or more volatile memory devices. In-line memory encryption, often referred to as memory encryption, is a technology used to enhance the security of data stored in a computer's memory. It works by automatically encrypting and decrypting data as it is written to or read from memory, respectively. This process can be managed by a memory encryption circuit, ensuring that data stored in memory is encrypted except when being processed by a host device (e.g., central processing unit (CPU)). In-line memory encryption can be used to protect sensitive data from unauthorized access, particularly physical attacks such as cold boot attacks, and enhancing the overall security posture of computing systems. This technology employs advanced cryptographic algorithms to ensure the confidentiality and integrity of the data while minimizing performance overhead. An in-line memory encryption (IME) circuit (or IME block) can be used in securing computing environments that handle sensitive or classified information, mitigating the risk of data breaches and enhancing privacy protections.

### BRIEF DESCRIPTION OF THE DRAWINGS

The present disclosure is illustrated by way of example, and not by way of limitation, in the figures of the accompanying drawings.

FIG. 1 is a block diagram of an in-line memory encryption with a power-aware cache system (IME-PACS) with an IME circuit having PACS logic according to at least one embodiment.

FIG. 2A is a block diagram of an IME-PACS in a power-down sequence from a normal mode to a shut-down mode according to at least one embodiment.

FIG. 2B is a block diagram of the IME-PACS in the shut-down mode after the power-down sequence according to at least one embodiment.

FIG. 2C is a block diagram of the IME-PACS in a power-up sequence from the shut-down mode to the normal mode according to at least one embodiment.

FIG. 3 is a block diagram of an IME-PACS with two caches according to at least one embodiment.

FIG. 4A illustrates a user cache line data with cache line data and EDC check symbols according to at least one embodiment.

FIG. 4B illustrates in-line metadata with metadata and EDC check symbols according to at least one embodiment.

FIG. 5 illustrates a cache line in which a message authentication code (MAC) is stored and transferred in side-band metadata associated with cache line data and a cache line in which a MAC is stored and transferred in in-band metadata associated with cache line data, according to various embodiments.

FIG. 6 is a flow diagram of a method of operating an IME-PACS according to at least one embodiment.

FIG. 7 is a block diagram of an integrated circuit with a memory controller, an IME block with PACS, error detection and correction (EDC) block, and a management processor according to at least one embodiment.

FIG. 8 is a block diagram of a memory system with a memory module with an IME block with PACS according to at least one embodiment.

### DETAILED DESCRIPTION

Technologies for in-line memory encryption with a power-aware cache system (IME-PACS) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, an IME circuit can be used in securing computing environments that handle sensitive or classified information, mitigating the risk of data breaches and enhancing privacy protections. In general, an IME circuit (or IME block), although needed for security and performance, can degrade the performance compared to a memory sub-system without an IME circuit. This can be a problem for adoption of technology, especially for the read path performance. In an IME system without caching capability, read and write operations require main memory access for every request. In an IME system with caching capability (referred to as a cache-enabled IME circuit or cache-enabled IME block), an instantaneous write request can be served by the cache, and data-in-cache can be written to main memory at a later time instance, if needed. The read request can be served by checking data in the cache and serving from the main memory when not present in the cache. But, if a read operation is on a recently updated data, then the latency to access the main memory can be reduced. Overall, the instantaneous read path bandwidth and latency can be optimized using cache flushing policies. This is important for host system operation (e.g., central processing unit (CPU) operation).

Some cache-enabled IME circuits can contain the most recent data used to prepare and normalize data for encryption or decryption. The cache can contain data that may still need to be flushed to main memory (e.g., off-chip memory) to avoid data loss before powering off. Current approaches includes a host system (i.e., software executing on the host system) that is responsible to ensure the cache is flushed before the power transition (i.e., shut off). The host system can flush the cache according to cache flush policies. The host system can also require control policies at a system level with a power management controller, including integration or handshakes with the IME circuit to handle a power down sequence. This is not only complex, but also requires bigger-than-necessary part of the design to remain involved.

During normal operations, the host system allocates a certain bandwidth to a write path to increase the probability of cached data being able to be written to the main memory when the power transition happens. By controlling the cache flush policies, the host system can maximize a read path performance, even at the cost of write path performance. However, delaying writes to the memory can cause potential data loss in the event of power transmissions. In the event of a power event (i.e., power transition), such as a shut-off or power-down event, the recent data on cache may be lost. In some cases, when recovering from a power-down state, it is advantageous to recover a previous cache state of the IME circuit back. The previous cache state refers to the data previously stored on cache of the IME circuit. When recovering from the power-down state, the empty cache has a potential negative impact on performance from the cache misses. In other cases, it might be desirable to not recover the previous cache state. These current approaches do not provide any configurability on whether to recover the previous cache state. Also, requiring a longer period to flush the cache may result in losing the opportunity to power-down the IME circuit. Also, some applications require increased security with minimal performance penalty in terms of power consumption and latency.

Aspects and embodiments of the present disclosure address the above and other deficiencies by providing a memory sub-system with in-line memory encryption and PACS logic (IME-PACS). Aspects and embodiments of the present disclosure can be implemented in an IME circuit (also referred to herein as IME block) that handles, automatically and transparently for the host system, cache flushes to main memory (also referred to as external memory or off-chip memory). Aspects and embodiments of the present disclosure can handle power mode transitions and sate recovery after transitions. The IME-PACS can enable a cache-enabled IME circuit to avoid potential data loss in a cache due to power mode transitions (e.g., power-down event), and recover a context (previous cache state) after power mode transitions (e.g., power-up event). The IME-PACS can maximize a read path bandwidth by facilitating opportunistic cache flush. An IME with PACS logic can provide autonomous power sequence handling capability in an IME circuit (or IME block) using a cache system for performance improvement with configurable cache policies, dedicated Control and Status Registers (CSRs) and a configuration interface for cache system status, a smart flush feature that can flush cache content to a memory controller when a power-down sequence starts, and control logic to handle the power-down sequence and power-up sequence.

An IME circuit with PACS logic can enable faster power-down sequences and power-up sequences by storing persistent valid flags along with the data fields with plaintext data in a cache of the IME circuit. In a power-off process, the PACS logic can cause cryptographic circuitry to encrypt the plaintext data of one or more cache entries having the persistent valid flags to obtain ciphertext data and store the ciphertext data in a memory system coupled to the IME circuit. In a power-on process, the PACS logic can load the ciphertext data from the memory system for the one or more cache entries having the first persistent valid flag set, cause the cryptographic circuitry to decrypt the ciphertext data to obtain the plaintext data for the one or more cache entries, and store the plaintext data in the one or more cache entries of the first cache.

The IME circuit with PACS logic can provide real-time encryption and decryption of data as it is read from or written to memory devices, while automatically and transparently caching data that can be flushed during a power-down process and restored during a power-up process. The IME circuit with PACS logic notify the host system when the cache has been flushed or restored, accordingly.

In addition to automatically flushing and restoring cache data without explicit commands or actions from an application or an operating system of a host device, the IME circuit with PACS logic ensures that cache data can automatically encrypted when being flushed to memory, such as dynamic random-access memory (DRAM) or any other type of computer memory, and automatically decrypted when being restored from the memory, without requiring explicit commands or actions from the application or the operating system of the host device. The encryption and decryption operations are performed in-line with the memory access operations, meaning they happen seamlessly and transparently during the data access process.

Aspects and embodiments of the present disclosure can provide various advantages in performance, power improvement, flexibility, reduction in system overhead, transparency and integration, etc. Aspects and embodiments of the present disclosure can achieve a significant reduction of time to flush applicable cache data and time to restore the flushed cached data, configured to do so. Aspects and embodiments of the present disclosure can provide power improvements for power-constrained devices by avoiding the entire cache being written to memory and retried from memory. Aspects and embodiments of the present disclosure can provide flexibility by providing configurability on whether the previous cache state should be recovered. For example, it might not be desirable to recover the previous cache state due to a context change. The configurability can be achieved using register-based programming, allowing an operating system (OS) to manage whether the previous cache state should be recovered. In at least one embodiment, dedicated Control and Status Registers (CSRs) can provide status of flushing and restoring cache data. In at least one embodiment, a Finite State Machine (FSM) in the PACS logic can be used for more complex status and programmability features. For example, a handshake between a host system and the PACS logic can be done the host system to exploit internal functionality of the memory sub-system. Aspects and embodiments of the present disclosure can reduce system overhead by automatically and transparently handling flushing and restoring cache data. The host system does not have to handle cache management or even having routines to wait a certain amount of time since the flushing and restoring are handled by the IME circuit. Aspects and embodiments of the present disclosure can provide transparency to and easy integration with a host system by using an internal design and state machine that work autonomously and provides handshake, control, and status signaling to the host system via a standard register interface. This can allow simple power event management without changing the overall system and software.

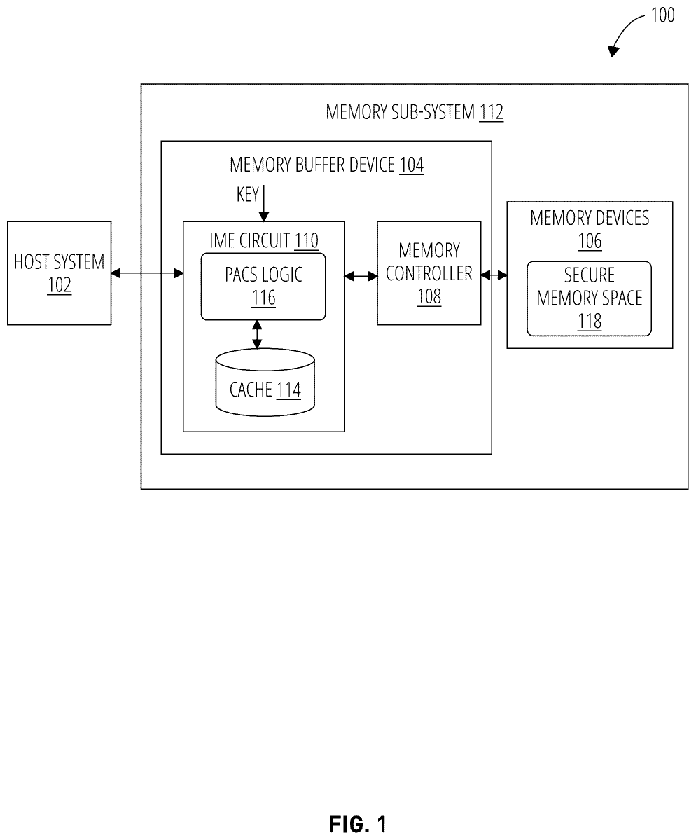

FIG. 1 is a block diagram of an IME-PACS 100 with an IME circuit 110 having PACS logic 116 according to at least one embodiment. The IME-PACS 100 includes a host system 102 coupled to a memory sub-system 112. The IME-PACS 100 can be implemented in any computing system, such as a System on Chip (SoC), a server, a personal computer, a mobile device, or the like. The memory sub-system 112 includes the IME circuit 110 having the PACS logic 116. The IME circuit 110 is coupled in-line between the host system 102 and one or more memory devices 106. The memory sub-system 112 can include a memory controller 108 coupled between the IME circuit 110 and the one or more memory devices 106. In at least one embodiment, the IME circuit 110 and the memory controller 108 are part of a memory buffer device 104, which is coupled between the host system 102 and the memory devices 106. In some embodiments, the memory buffer device 104 is a CXL buffer. In some embodiments, the IME circuit 110 is part of a remote memory module.

In at least one embodiment, the memory devices 106 can be one or more dynamic random-access memory (DRAM) devices, static random access memory (SRAM) devices, other volatile memory devices, non-volatile memory devices, or the like. The memory devices 106 can be organized to provide one or more memory spaces, including a secure memory space 118. The memory controller is circuitry or a component in computing systems responsible for managing communications and data transactions between the host system 102 can the memory sub-system 112, which can be the main memory. The memory controller 108 controls the flow of data into and out of the memory buffer device 104, ensuring that the host system 102 has timely access to data stored in the memory devices 106 for processing tasks. The memory controller 108 can perform various functions, including managing the memory's addressing, timing, and data pathways, thereby optimizing read and write operations to the memory devices 106. In some cases, the memory controller 108 can be integrated into a circuit board, such as on a motherboard as part of a northbridge chipset. In other embodiments, the memory controller 108 can be integrated into a processor die coupled between the host system 102 and the memory devices 106. The memory controller 108 can support communication protocols and various types of memory technologies, such as Double Data Rate (DDR), Synchronous Dynamic RAM (SDRAM), and emerging memory standards. The memory controller 108 can have different memory bandwidths, latencies, and abilities to handle sequential or concurrent memory requests. Advanced features in memory controllers may include support for error-correcting code (ECC) memory, which can detect and correct data corruption, and memory interleaving, which spreads memory accesses across multiple memory banks to improve bandwidth and reduce bottlenecks.

In at least one embodiment, the host system 102 can refer to a computer or a computing device that provides resources, services, or applications to one or more user machines, known as clients, or supports the operation of guest systems in a virtualized environment. In a networking context, the host system 102 could be a server that hosts applications, data, or services accessed by client computers over a network. This includes web servers, database servers, file servers, and mail servers, which serve respective content or services to client devices upon request. In the context of virtualization or cloud computing, the host system 102 is often a physical machine that runs virtualization software (e.g., a hypervisor), allowing it to operate multiple virtual machines (VMs) or guest systems concurrently. These virtual machines behave as distinct computing entities, encapsulating an operating system and applications, and they rely on the host system's hardware resources (such as central processing unit (CPU), memory, and storage) to run. The primary function of the host system 102 is to ensure the availability, reliability, and security of its resources and services for the clients or guest systems that depend on it. The host system 102 can be used in managing and allocating its resources efficiently to meet the demands of its users or guest operating systems, ensuring optimal performance and service quality.

In at least one embodiment, the IME circuit 110 is specialized circuitry or component designed to secure data stored in the secure memory space 118 by encrypting the data as it is written to and decrypting it as it is read from the secure memory space 118. The IME circuit 110 ensures that data remains encrypted while it resides in the memory devices 106, thereby protecting sensitive information from unauthorized access and attacks. The IME circuit 110 operates by interfacing directly with the memory controller 108 to perform real-time encryption and decryption of data using cryptographic keys. The IME circuit 110 integrates seam lessly into the memory access pathways, ensuring that encryption and decryption processes are transparent to the host system 102 and its operation with minimal impact on performance. The IME circuit 110 handles key management, including the secure generation, storage, and handling of encryption keys to maintain the confidentiality and integrity of the data. By protecting data directly within the secure memory space 118, IME circuit 110 can mitigate the risk of data exposure through physical attacks, cold boot attacks, and other memory-related security vulnerabilities. Additionally, the IME circuit 110 can contribute to secure boot processes or other security measures, such as disk encryption, to provide comprehensive protection for sensitive information across the system.

As illustrated in FIG. 1, the IME circuit 110 includes a cache 114. The cache 114 includes cache entries, where each cache entry can have a persistent valid flag, a persistent modified flag, a tag, and a data field for plaintext data. In a power-off process, the PACS logic 116 can cause cryptographic circuitry of the IME circuit 110 to encrypt the plaintext data of one or more cache entries having at least the persistent valid flag set to obtain ciphertext data for the one or more cache entries. The PACS logic 116 can cause the ciphertext data to be stored in the memory devices 106 (secure memory space 118) via the memory controller 108. In a power-on process, the PACS logic 116 can load the ciphertext data from the memory devices 106 for the one or more cache entries having at least the persistent valid flag set. The PACS logic 116 can cause the cryptographic circuitry to decrypt the ciphertext data to obtain the plaintext data for the one or more cache entries, and store the plaintext data in the one or more cache entries of the cache 114.

In other embodiments, in the power-off process, the processing logic can cause the cryptographic circuitry to encrypt the plaintext data of the one or more cache entries having the persistent valid flag and the modified flag set to obtain the ciphertext data for the one or more cache entries. Similarly, in the power-on process, the processing logic can cause load the ciphertext data from the memory devices 106 for the one or more cache entries having the persistent valid flag and the modified flag set.

In at least one embodiment, a tag field in the cache entry can store tag data associated with the plaintext data. The tag data can be an address or a portion of an address. The tag data can be stored in the cache 114 along with the plaintext data and in memory devices 106 along with the ciphertext data when the valid flag (and the modified flag) is set. The tag data can be used to retrieve the ciphertext data from the memory devices 106 and store with the plaintext data in the cache 114.

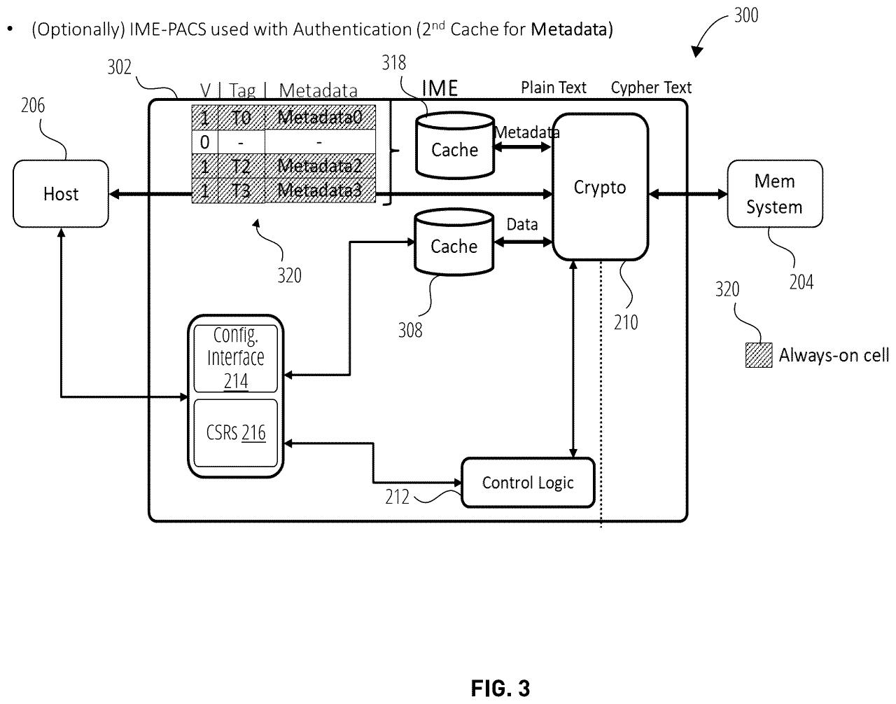

In at least one embodiment, the IME circuit 110 includes a second cache with entries to store a second persistent flag and a second data field for metadata associated with the respective plaintext data of the corresponding cache entry in the cache 114, such as illustrated and described below with respect to FIG. 3. The metadata can be a message authentication code (MAC). The metadata can be a message integrity code (MIC). The metadata can be other types of data associated with the corresponding cache entry in the 114, such as authentication data for the corresponding cache entry, a hash of the data in the corresponding cache entry, or the like.

In at least one embodiment, the cache 114 can include a tag field for first tag data associated with plaintext data. The second cache can include a tag field for second tag data associated with the metadata. Alternatively, the second cache can store other data that can be separately stored from the corresponding plaintext data in the cache 114.

In at least one embodiment, in the power-off process, the PACS logic 116 can send a first signal to the host system 102, the first signal indicating a first status of the power-off process. In the power-on process, the PACS logic 116 can send a second signal to the host system 102, the second signal indicating a second status of the power-on process.

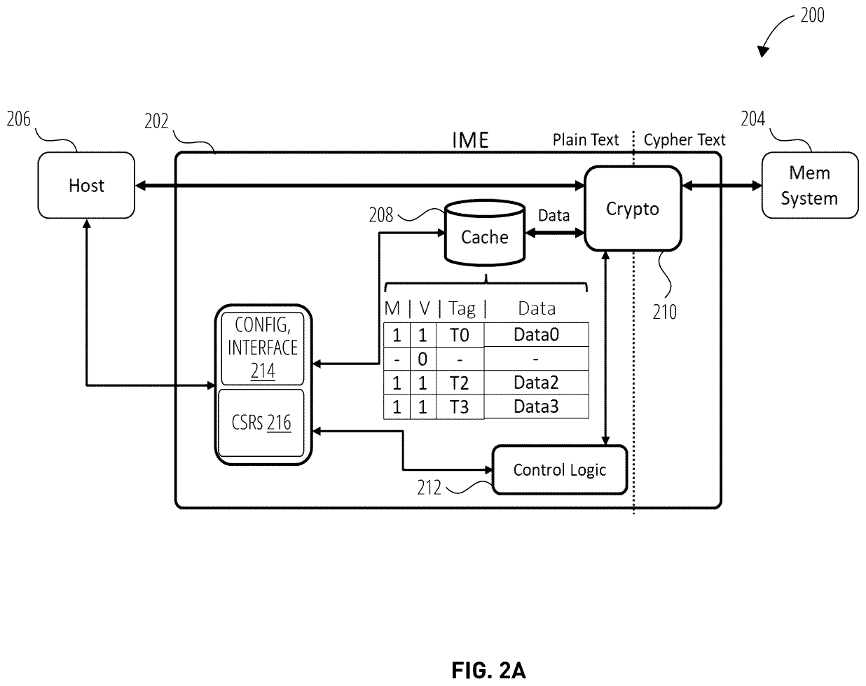

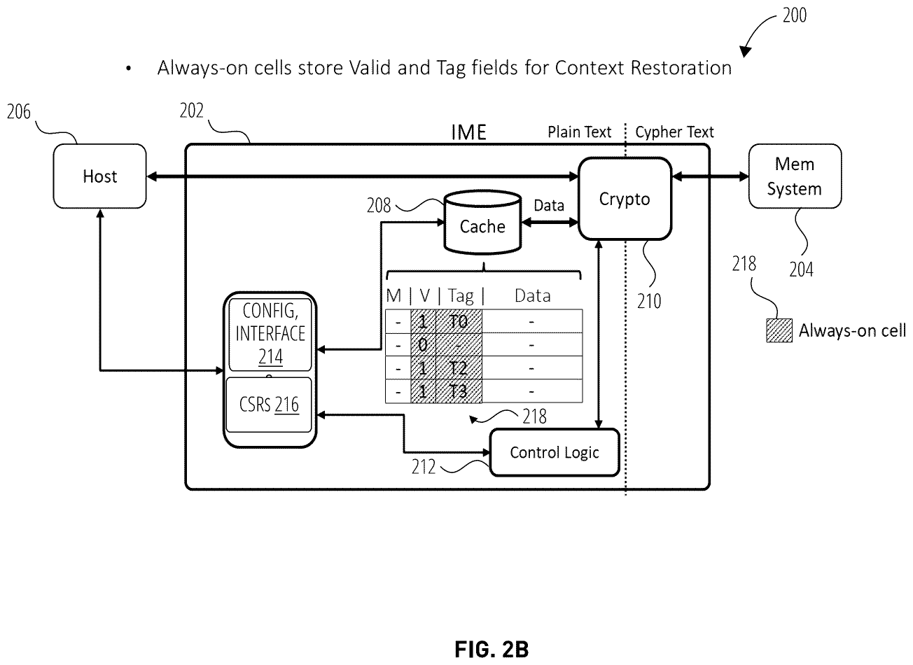

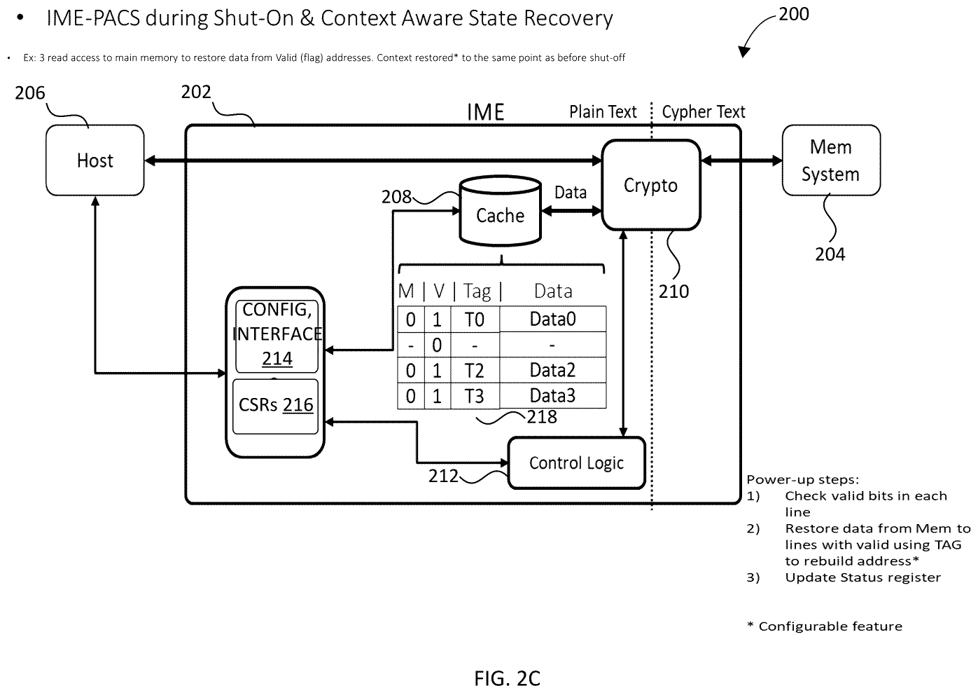

An example of the PACS logic 116 before, during, and after a power event (e.g., power-down event) is illustrated and described below with respect to FIG. 2A, FIG. 2B, and FIG. 2C.

FIG. 2A is a block diagram of an IME-PACS 200 in a power-down sequence from a normal mode to a shut-down mode according to at least one embodiment. The IME-PACS 200 and the IME circuit 202 can be similar to the IME-PACS 100 and IME circuit 110 of FIG. 1, respectively, as described above. The IME-PACS 200 includes an IME circuit 202 coupled between a memory system 204 and a host system 206. The IME circuit 202 includes a cache 208, a cryptographic circuitry 210, control logic 212, a configuration interface 214, and a CSRs 216. In the power-down sequence, the IME-PACS 200 can perform a smart flush process as described in more detail below, and update the CSRs 216. The smart flush process can start as a result of a power event. The IME-PACS 200 can receive a signal from the host system 206, the signal indicating that the host system 206 is powering down. Alternatively, the IME-PACS 200 can receive a signal from a power management controller. The IME-PACS 200 can detect the power event in other manners. In the smart flush process, the control logic 212 can determine which cache entries in the cache 208 have valid flags and modified flags set. The control logic 212 can cause these cache entries to be flushed to the memory system 204. That is, the control logic 212 can send the data (cache line data) in these cache entries to the cryptographic circuitry 210 to be encrypted before being sent to the memory system 204, such as via a memory controller (not illustrated in FIG. 2A). The control logic 212 can update the CSRs 216 accordingly. In some embodiments, the cache 208 can store tag data in each of the cache entries. The data and the tag data can be flushed to the memory system 204 in the power-down sequence responsive to the valid flag and modified flag being set. In other embodiments, the data and the tag data can be flushed to the memory system 204 in the power-down sequence responsive to the valid flag being set.

In at least one embodiment, the IME circuit 202 include a configuration interface 214 to provide programmability to the host system 206. For example, the IME circuit 202 can be configured to specify that both the valid flag and modified flag need to be set to flush a cache entry. The IME circuit 202 can be configured to enable or disable cache flushing, cache restoration, or the like. The configuration interface 214 can be implemented with control registers in the CSRs 216. The host system 206 can store one or more values in one or more control registers to configure the IME circuit 202. The configuration interface 214 can be used to configure a first portion of the cache 208 to have cache entries for flushing and a second portion of the cache 208 to have cache entries that are not flushed in a power-down sequence.

As described in more detail below with respect to FIG. 2B, the cache 208 includes persistent cells 218 (also referred to as always-on cells) to store some of the data in the cache entries through a power cycle. That is, even when the IME circuit 202 does not have power, the data in the persistent cells 218 persist. In at least one embodiment, the persistent cells 218 stores the valid flag for context restoration. The persistent cells 218 can also store tag data for the respective cache entry. The tag data, such as an address or an index, can be used when the data is stored to the cache 208. In some cases, the tag data and the valid flag are stored for each cache entry in the cache 208, regardless of whether the valid flag is set. If a cache entry is not set, the data is not restored, but the tag can maintain an order in which the restored data is restored back to cache entries where the valid flags are set.

FIG. 2B is a block diagram of the IME-PACS 200 in the shut-down mode after the power-down sequence according to at least one embodiment. As described above, the data in the persistent cells 218 persist in the cache 208 in the shut-down mode after the power-down sequence. The persistent cells 218 can store the valid and tag fields for context restoration in a power-up sequence, such as illustrated and described below with respect to FIG. 2C.

FIG. 2C is a block diagram of the IME-PACS 200 in a power-up sequence from the shut-down mode to the normal mode according to at least one embodiment. In the power-down sequence, the IME-PACS 200 can perform a context-aware state recovery process. In the context-aware state recovery process, the IME-PACS 200 checks valid bits in each line stored in the memory system 204, restores data from the memory system 204 having the valid bits set, and updates the status in the CSRs 216. In at least one embodiment, the IME-PACS 200 can use the tag data to rebuild an address of the cache entry. This can be a configurable feature that can be configured via the configuration interface 214. The tag data stored in memory system 204 can be used to match the tag data stored in the persistent cells 218. In this manner, the context-aware state recovery can restore the data in the cache 208 to the same point as before the power-down sequence. The IME circuit 202 can perform read access operations to restore data with valid addresses, as designed by the valid flags, in the memory system 204, into the corresponding cache entries of the cache 208.

As illustrated in FIG. 2A to FIG. 2C, the IME-PACS 200 can flush cache data having at least the valid flags set in the cache 208 and restore the cache data to the cache 208 through power transitions of a power cycle.

FIG. 3 is a block diagram of an IME-PACS 300 with two caches according to at least one embodiment. The IME-PACS 300 and the IME circuit 302 are similar to the IME-PACS 200 and IME circuit 302 as noted by similar reference numbers except the IME circuit 302 includes a first cache 308 and a second cache 318. Similar to the cache 208 of FIG. 2A, the first cache 308 includes cache entries, were each cache entry has a first persistent valid flag, a first data field for plaintext data, a first modified flag, and a tag field. In other embodiments, each cache entry has at least the first persistent valid flag and the first data field. The second cache 318 include cache entries, where each cache entry has a second persistent valid flag and a second data field for metadata associated with the respective plaintext data of the corresponding cache entry of the first cache 308.

Similar to the cache 208 described above with respect to FIG. 2A-FIG. 2C, the first cache 308 includes persistent cells (also referred to as always-on cells) to store some of the data in the cache entries through a power cycle. The second cache 318 also includes persistent cells 320 to store some metadata associated with the cache entries through the power cycle. That is, even when the IME circuit 302 does not have power, the data in the persistent cells of the first cache and the persistent cells 320 of the second cache 318 persist. In at least one embodiment, the persistent cells 320 stores the valid flag, the tag fields, and the data fields with the metadata for context restoration. The persistent cells 320 can store just the valid flag and the data fields with the metadata. The tag data, such as an address or an index, can be used when the data is stored to the first cache 308 and metadata is stored in the second cache 318. In some cases, the tag data, the valid flag, and the metadata are stored for each cache entry in the second cache 318, regardless of whether the valid flag is set. If a cache entry is not set, the metadata is not restored, but the tag data can maintain an order in which the restored metadata is restored back to cache entries where the valid flags are set.

In one embodiment, an IME circuit includes a first cache. The IME circuit also includes cryptographic circuitry; and control circuitry, where the control circuitry is to store first plaintext data in a first cache entry of the first cache, set a first valid flag in the first cache entry, where the first valid flag is stored in an always-on cell of the first cache, receive a first indication of a first power event, and in response to receiving the first indication, encrypt, using the cryptographic circuitry, the first plaintext data to obtain first ciphertext data. The IME circuit also includes store the first ciphertext data in a memory coupled to the IME circuit. The IME circuit may also include where the control circuitry is further to receive a second indication of a second power event, and in response to receiving the second indication, load the first ciphertext data from the memory; decrypt, using the cryptographic circuitry, the first ciphertext data to obtain the first plaintext data. The IME circuit may also include store the first plaintext data in the first cache. The IME circuit may also include further includes a second cache, where the control circuitry is further to store first metadata in a first cache entry of the second cache, set a second valid flag in the first cache entry of the second cache, where the first metadata and the second valid flag are stored in always-on cells of the second cache, and in response to receiving the first indication, store the first metadata in the memory. The IME circuit may also include where the control circuitry is further to store a first tag associated with the first plaintext data in the first cache entry, where the first tag is stored in always-on cells of the first cache, receive a second indication of a second power event, and in response to receiving the second indication, load, using the first tag, the first ciphertext data from the memory; and decrypt, using the cryptographic circuitry, the first ciphertext data to obtain the first plaintext data. The IME circuit may also include store the first plaintext data in the first cache entry with the first tag stored in the always-on cells of the first cache. Other technical features may be readily apparent to one skilled in the art from the following figures, descriptions, and claims. The IME circuit may also include where the control circuitry is further to receive a second indication of a second power event, and in response to receiving the second indication, load the first ciphertext data and the first metadata from the memory; decrypt, using the cryptographic circuitry, the first ciphertext data to obtain the first plaintext data; store the first plaintext data in the first cache. The IME may also include store the first metadata in the second cache. The IME circuit may also include further includes a second cache, where the control circuitry is further to store first metadata and the first tag in a first cache entry of the second cache, set a second valid flag in the first cache entry of the second cache, where the first metadata, the first tag, and the second valid flag are stored in always-on cells of the second cache, and in response to receiving the first indication, store the first metadata and the first tag in the memory.

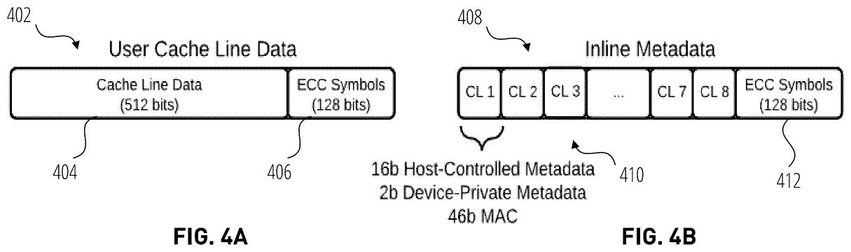

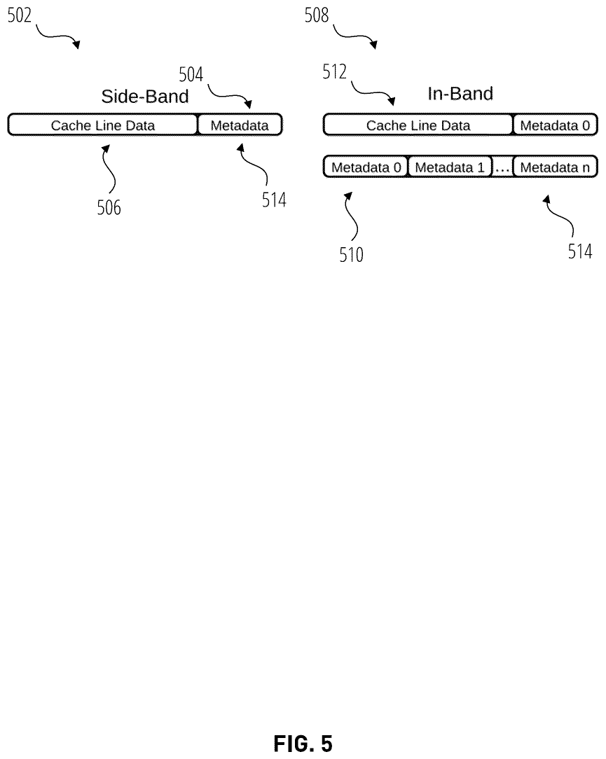

The cache line data and the metadata can be stored in different formats in the memory system 204, such as illustrated and described below with respect to FIG. 4A, FIG. 4B, and FIG. 5.

FIG. 4A illustrates a user cache line data 402 with cache line data 404 and EDC check symbols 406 according to at least one embodiment. The user cache line data 402 can be stored in a first cache line. The first cache line can have a first address. The EDC check symbols 406 can be stored with the cache line data 404 in the user cache line data 402. Alternatively, the user cache line data 402 can store only the cache line data 404, and the EDC check symbols 406 can be stored in another location (as a second cache line), such as illustrated in FIG. 4B.

FIG. 4B illustrates in-line metadata 408 with metadata 410 and EDC check symbols 412 according to at least one embodiment. In at least one embodiment, the metadata 410 can include host-controlled metadata, device-private metadata, a MAC, or the like. The metadata can also store counters, such as counters used to prevent replay attacks, as well as counters associated with the number of MAC verification failures. The in-line metadata 408 can be stored in a second cache line. The second cache line can have a second address that is different than the first address.

As described herein, the EDC check symbols are stored in the same cache line as the data they are protecting (e.g., side-band) or in a different cache line as the data they are protecting (e.g., in-band), as illustrated in FIG. 5.

FIG. 5 illustrates a cache line 502 in which EDC check symbols 514 are stored and transferred in side-band metadata 504 associated with cache line data 506 and a cache line 508 in which EDC check symbols 514 are stored and transferred in in-band metadata 510 associated with cache line data 512, according to various embodiments. In general, the metadata includes host-controlled metadata, device-private metadata, a MAC, or the like, and the EDC check symbols 514. The metadata can be stored as side-band metadata 504 or in-band metadata 510. The side-band metadata 504 can be accessible when the cache line 502 is read from memory. The in-band metadata 510 can be stored in another location than the cache line data 512, such as in a static RAM (SRAM) or DRAM. When the cache line data 512 is read, an additional memory read would be performed to retrieve the in-band metadata 510, including the EDC check symbols 514. In some cases, the in-band metadata 510 only includes the EDC check symbols 514 and is only accessed when needed.

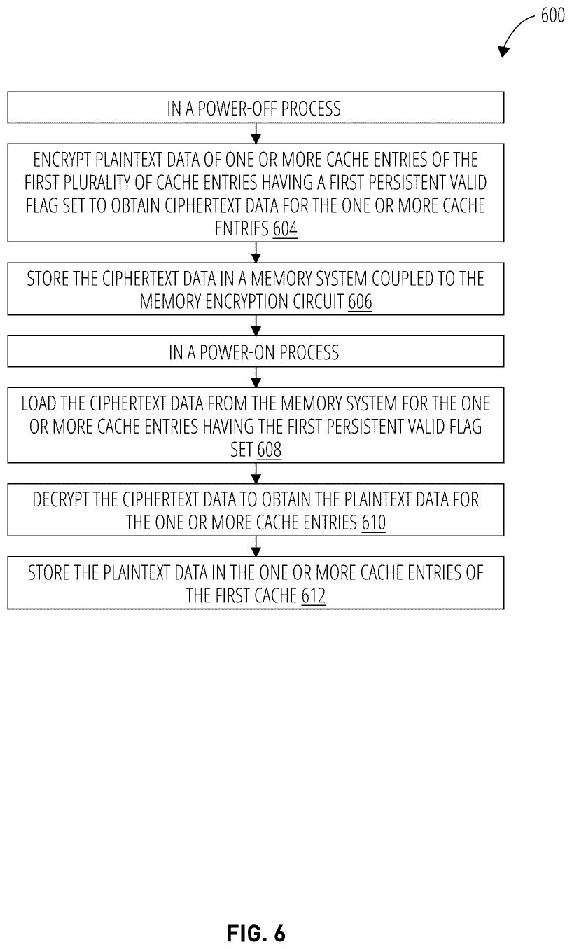

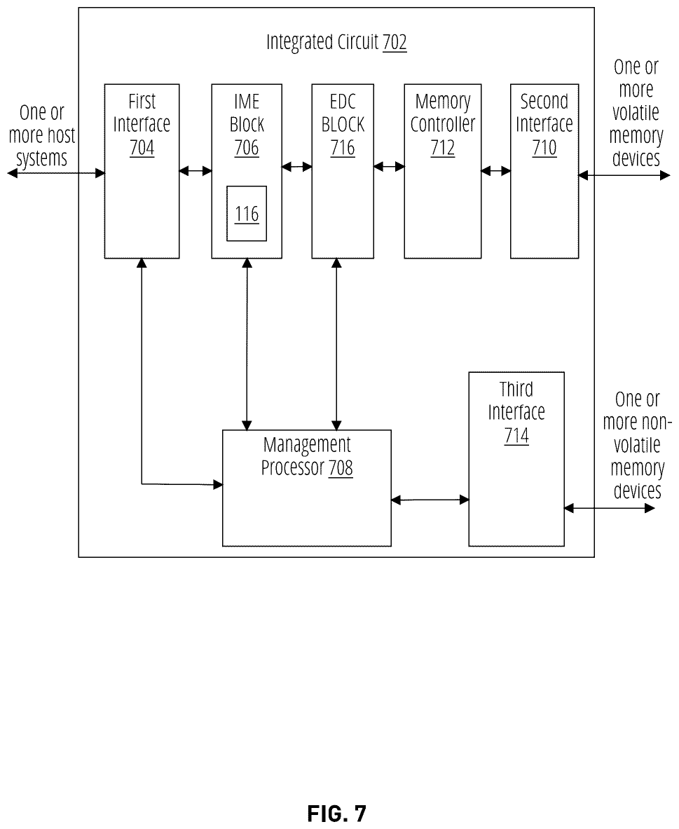

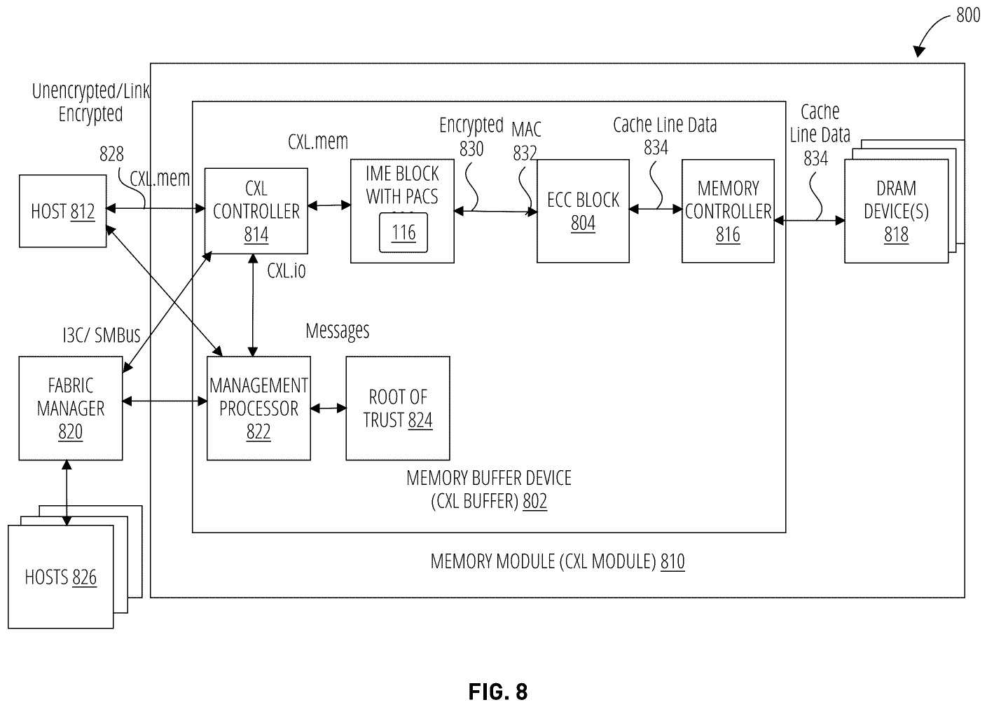

FIG. 6 is a flow diagram of a method 600 of operating an IME-PACS according to at least one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 600 is performed by any of the hardware described above with respect to FIG. 1 to FIG. 3. In one embodiment, the method 600 is performed by any of the hardware described below with respect to FIG. 7 or FIG. 8. In one embodiment, the method 600 is performed by the memory sub-system 112, the memory buffer device 104, the IME circuit 110, or the PACS logic 116 of FIG. 1. In one embodiment, the method 600 is performed by the IME circuit 202, the control logic 212 of FIG. 2A-FIG. 2C. In one embodiment, the method 600 is performed by the IME block with PACS 706 or the integrated circuit 702 of FIG. 7. In one embodiment, the method 600 is performed by the IME block with PACS 806 or the memory buffer device 802 of FIG. 8. In at least one embodiment, the 600 is performed by a memory buffer device, a memory expansion device, a memory module (e.g., memory module 810 of FIG. 8), or the like.

Referring to FIG. 6, the method 600 begins with the processing logic, in a power-off process, the processing logic encrypts plaintext data of one or more cache entries of the first plurality of cache entries having a first persistent valid flag set to obtain ciphertext data for the one or more cache entries (block 602). At block 604, the processing logic stores the ciphertext data in a memory system coupled to the memory encryption circuit. In a power-on process, the processing logic loads the ciphertext data from the memory system for the one or more cache entries having the first persistent valid flag set (block 606). At block 608, the processing logic decrypts the ciphertext data to obtain the plaintext data for the one or more cache entries. At block 610, the processing logic stores the plaintext data in the one or more cache entries of the first cache.

In at least one embodiment, the processing logic encrypts the plaintext data of the one or more cache entries having the first persistent valid flag set and a first modified flag set to obtain the ciphertext data for the one or more cache entries. In at least one embodiment, in the power-off process, the processing logic stores tag data, associated with the plaintext data of one or more cache entries of the first plurality of cache entries having the first persistent valid flag, in the memory system. The tag data can be stored in persistent cells of the first cache. In at least one embodiment, in the power-on process, the processing logic loads the ciphertext data from the memory system using the tag data stored in the persistent cells of the first cache. The processing logic stores the plaintext data in the one or more cache entries with the tag data.

In at least one embodiment, the processing logic stores, in a second cache, a second persistent valid flag and metadata associated with the respective plaintext data of the corresponding cache entry of the first cache. The second persistent valid flag and metadata can be stored in persistent cells of the first cache. In at least one embodiment, the metadata includes a MAC of the respective plaintext data of the corresponding cache entry of the first plurality of cache entries.

In at least one embodiment, the processing logic stores, in the first cache, tag data associated with the plaintext data of the first plurality of cache entries. The tag data can be stored in persistent cells of the first cache. The processing logic stores, in a second cache, the tag data. The tag data can be stored in persistent cells of the second cache. In at least one embodiment, in the power-off process, the processing logic stores tag data, associated with the plaintext data of one or more cache entries of the first plurality of cache entries having the first persistent valid flag, in the memory system. In at least one embodiment, in the power-on process, the processing logic loads the ciphertext data from the memory system using the tag data stored in the persistent cells of the first cache. The processing logic stores the plaintext data in the one or more cache entries with the tag data.

In at least one embodiment, in the power-off process, the processing logic sends a first signal to a host system coupled to the memory encryption circuit, the first signal indicating a status of the power-off process. In at least one embodiment, in the power-on process, the processing logic sends a second signal to the host system, the second signal indicating a status of the power-on process.

In at least one embodiment, the IME-PACS can include a smart flush mechanisms to avoid potential data loss during power mode transitions by flushing only modified data to main memory. The IME-PACS can include a configurable context-aware state recovery mechanism to restore cache data after power transition (shut-on). This can allow for a reduction in potential performance penalty. Also, the configurability of the IME-PACS allows the mechanisms to be disabled. For example, the context-aware state recovery mechanism can be disabled if after shut-on a different context will use the hardware resources. The IME-PACS can provide a smart way to flush the cache to mitigate potential data loss and maximize a read path bandwidth in favor of write bandwidth.

In at least one embodiment, in a memory encryption engine with a first cache, each cache entry can have an always-on valid flag and a data field for plaintext data. In a power-off process, the memory encryption engine encrypts a data of cache entries having the always-on valid flag set and stores to a memory (e.g., main memory). In a power-on process, the memory encryption engine loads data from the memory for cache entries having the always-on valid flag set and decrypts the data. In a further embodiment, the memory encryption engine has a second cache where the data field of cache entry is metadata and MAC (hash of the data) for authentication. In a further embodiment, a signal between the memory encryption engine and a host can be used during a power-mode transition to control a bandwidth of the memory accesses.

In at least one embodiment, the IME-PACS includes a cache system, CSR registers, always-on cells (programmable), and control logic. The CSRs can include a global status flag that indicates globally if there is data in the cache that is not in the memory yet. The CSRs can indicate a status of the power-down sequence and/or the power-up sequence. For example, the CSR can indicate if the IME is still busy doing cache flushing, or the CSRs can indicate if the IME is ready after the power-up event. The control logic can send a status signal to the CSRs to indicate the status of the power-down sequence or the power-up sequence. In at least one embodiment, interface logic can receive the global status signal from the cache and the control status signal from the control logic and store this information in one or more registers or provide signals to the host. For example, during a smart flush operation in a power-down sequence, if the modified flag is set (indicating that data in the cache is different from RAM (modified) in memory, data from that cache line is flushed to memory. The always-on cells can store the valid and tag fields in the cache for context restoration. During power-on process of the power-up sequence, the IME can access the memory to read valid (flag) address in memory to restore them to the cache. That is, the context is restored to the same point as before the shut-down.

FIG. 7 is a block diagram of an integrated circuit 702 with a memory controller 712, an IME block with PACS 706, error detection and correction (EDC) block 716, and a management processor 708 according to at least one embodiment. In at least one embodiment, the integrated circuit 702 is a memory buffer device that can communicate with one or more host systems (not illustrated in FIG. 7) using a cache-coherent interconnect protocol (e.g., the Compute Express Link™ (CXL™) protocol). The integrated circuit 702 includes a first interface 704 coupled to the one or more host systems or a fabric manager, a second interface 710 coupled to one or more volatile memory devices (not illustrated in FIG. 7), and an optional third interface 714 coupled to one or more non-volatile memory devices (not illustrated in FIG. 7). The one or more volatile memory devices can be DRAM devices. The integrated circuit 702 can be part of a single-host memory expansion integrated circuit, a multi-host memory pooling integrated circuit coupled to multiple host systems over multiple cache-coherent interconnects, or the like.

In one embodiment, the memory controller 712 receives data from a host over the first interface 704 or from a volatile memory device over the second interface 710. The memory controller 712 can send the data or a copy of the data to the IME block with PACS 706. The IME block with PACS 706 can include PACS logic 116 that can autonomously split a secure memory space into a plurality of subspaces and sanitize the subspaces, providing back-pressure to the one or more host systems, as described herein.

In at least one embodiment, one or more errors can be detected and/or corrected by the EDC block 716. The EDC block 716 can generate and/or use a message authentication code (MAC) in the received data. The EDC block 716 can send a notification of an EDC event to the host or fabric manager via the memory controller 712 or the management processor 708.

In at least one embodiment, the IME block with PACS 706 includes the PACS logic 116 and the cache 114 of FIG. 1 (the cache 208 of FIG. 2A-FIG. 2C or the first cache 308 and second cache 318 of FIG. 3) as described above. In at least one embodiment, the IME block with PACS 706 can be part of a remote memory module. The IME block with PACS 706 can be a CXL buffer that implements the CXL technology. The memory controller 712 can be a CXL controller coupled to the IME block with PACS 706. The CXL controller can be compliant with the CXL protocol.

In another embodiment, the IME block with PACS 706 can include an encryption circuit that can encrypt data being stored in the one or more volatile memory devices or one or more non-volatile memory devices coupled to the management processor 708 via a third interface 714. In another embodiment, the one or more non-volatile memory devices are coupled to a second memory controller of the integrated circuit 702.

In another embodiment, the integrated circuit 702 is a processor that implements the CXL™ standard and includes the IME block with PACS 706 and memory controller 712. In another embodiment, the integrated circuit 702 can include more or fewer interfaces than three.

In at least one embodiment, the integrated circuit 702 can be a device that supports the CXL® technology. The CXL™ protocol can be built upon physical and electrical interfaces of a Peripheral Component Interface Express® (PCI Express®) standard with protocols that establish coherency, simplify the software stack, and maintain compatibility with existing standards. The integrated circuit 702 can include a CXL® controller or a CXL® memory expansion device (e.g., CXL® memory expander System on Chip (SoC)) that is coupled to DRAM devices (e.g., one or more volatile memory devices) and/or persistent storage memory (e.g., one or more non-volatile memory devices (NVM devices). The CXL® memory expansion device can include the management processor 708. The CXL® memory expansion device can include the IME block with PACS 706 to detect and correct errors in data read from memory or transferred between entities. The CXL® memory expansion device can use an in-line memory encryption (IME) circuit, to encrypt the host's unencrypted data before storing it in the DRAM device. The IME circuit can generate a message authentication code (MAC) that can be used to verify the encrypted data. In another embodiment, the integrated circuit 702 can include an ECC block or circuit that can generate or verify ECC information associated with the data. In another embodiment, one or more non-volatile memory devices are coupled to a second memory controller of the integrated circuit 702. In another embodiment, the integrated circuit 702 is a processor that implements the CXL® standard and includes an in-line EDC logic and a memory controller 712.

In at least one embodiment, the integrated circuit 702 or IME block with PACS 706 of FIG. 7 can perform the operations of method 600 of FIG. 6 described above.

FIG. 8 is a block diagram of a memory system 800 with a memory module 810 with an IME block with PACS 806 according to at least one embodiment. In one embodiment, the memory module 810 includes a memory buffer device 802 and one or more DRAM device(s) 818. In one embodiment, the memory buffer device 802 is coupled to one or more DRAM device(s) s 818 and a host 812. In another embodiment, the memory buffer device 802 is coupled to a fabric manager 820 that is operatively coupled to one or more hosts 826. In another embodiment, the memory buffer device 802 is coupled to both the host 812 and the fabric manager 820. A fabric manager is software executed by a device, such as a network device or switch that manages connections between multiple entities in a network fabric. The network fabric is a network topology in which components pass data to each other through interconnecting switches. A network fabric includes hubs, switches, adapter endpoints, etc., between devices.

In one embodiment, the memory buffer device 802 includes an ECC block 804 (e.g., ECC circuit) to detect and correct errors in cache lines being read from a DRAM device(s) 818, and an IME block with PACS 806 to generate a message authentication code (MAC) for each cache line to provide cryptographic integrity on accesses to the respective cache line. The IME block with PACS 806 include the PACS logic 116 that performs various operations described herein.

In a further embodiment, the memory buffer device 802 includes a CXL controller 814 and a memory controller 816. The CXL controller 814 is coupled to host 812 or multiple hosts 826 via the fabric manager 820. The memory controller 816 is coupled to the one or more DRAM devices 818. In a further embodiment, the memory buffer device 802 includes a management processor 822 and a root of trust 824. In at least one embodiment, the management processor 822 receives one or more management commands through a command interface between the host 812 (or fabric manager 820) and the management processor 822. In at least one embodiment, the memory buffer device 802 is implemented in a memory expansion device, such as a CXL memory expander SoC of a CXL NVM module or a CXL module. The memory buffer device 802 can encrypt unencrypted data 828 (e.g., plain text or cleartext user data), received from a host 812, using the IME block with PACS 806 to obtain encrypted data 830 before storing the encrypted data 830 in DRAM device(s) 818. In some cases, the IME block with PACS 806 can receive data that is encrypted for transmission across the link. The IME block with PACS 806 can generate check symbols associated with the encrypted data 830. In at least one embodiment, the IME block with PACS 806 is an IME engine. In another embodiment, the IME block with PACS 806 is an encryption circuit or encryption logic. The ECC block 804 can receive the encrypted data 830 from the IME block with PACS 806. The ECC block 804 can generate ECC information associated with the encrypted data 830. The encrypted data 830, the check symbols, and the ECC information can be organized as cache line data 834. The memory controller 108 can receive the cache line data 834 from the ECC block 804 and store the cache line data 834 in the DRAM device(s) 818. It should be noted that the memory buffer device 802 can receive unencrypted data, but can also receive data that is encrypted as it traverses a link (e.g., the CXL link). This encryption is usually a link encryption, generally referred to in CXL as integrity and data encryption. The link encryption in this case would not persist to DRAM as the CXL controller 814 in the memory module 810 can decrypt the link data and verify its integrity prior to the flow described herein where the IME block with PACS 806 encrypts the data and generates the check symbols. Although “unencrypted data 828” is used herein, in other embodiments, the data can be encrypted data that is encrypted by the memory buffer device 802 using a key only used for the link and thus cleartext data exists within the SoC after the CXL controller 814 and thus needs to be encrypted by the IME block with PACS 806 to provide encryption for data at rest. In other embodiments, the IME block with PACS 806 does not encrypt the data but still generate the check symbols.

In at least one embodiment, the CXL controller 814 includes two interfaces, a host memory interface (e.g., CXL.mem) and a management interface (e.g., CXL.io). The host memory interface can receive, from the host 812, one or more memory access commands of a remote memory protocol, such as Compute Express Link (CXL) protocol, Gen-Z, Open Memory Interface (OMI), Open Coherent Accelerator Processor Interface (OpenCAPI), or the like. The management interface can receive, from the host 812 or the fabric manager 820 by way of the management processor 122, one or more management commands of the remote memory protocol.

In at least one embodiment, the IME block with PACS 806 includes the PACS logic 116 and the cache 114 of FIG. 1 (the cache 208 of FIG. 2A-FIG. 2C or the first cache 308 and second cache 318 of FIG. 3) as described above. In at least one embodiment, the IME block with PACS 806 receives a data stream from a host 812 and encrypts the data stream into the encrypted data 830, and provides the encrypted data 830 to the ECC block 804 and the memory controller 816. The memory controller 816 stores the encrypted data 130 in the DRAM device(s) 818 along with the check symbols 832 and the ECC information as the cache line data 834.

In some embodiments, the memory module 810 has persistent memory backup capabilities where the management processor 822 can access the encrypted data 830 and transfer the encrypted data from the DRAM device(s) 818 to persistent memory (not illustrated in FIG. 8) in the event of a power-down event or a power-loss event. The encrypted data 830 in the persistent memory is considered data at rest. In at least one embodiment, the management processor 822 transfers the encrypted data to the persistent memory using an NVM controller (e.g., NAND controller).

The IME block with PACS 806 can include multiple encryption functions, such as a first encryption function that uses 256-AES encryption and a second encryption function that uses 512-AES encryption. In other embodiments, the encryption functions can also provide cryptographic integrity, such as using a message authentication code (MAC). In other embodiments, the cryptographic integrity can be provided separately from the encryption function. In some cases, the strength of the MAC and encryption algorithms can be different. The first encryption function can have a first encryption strength, such as 256-AES encryption. In at least one embodiment, the IME block with PACS 806 is an IME engine with two encryption functions. In another embodiment, the IME block with PACS 806 includes two separate IME engines, each having one of the two encryption functions. In another embodiment, the IME block with PACS 806 includes a first encryption circuit for the first encryption function and a second encryption circuit for the second encryption function.

Alternatively, additional encryption functions can be implemented in the IME block with PACS 806. The memory controller 816 can receive the encrypted data 830 from the IME block with PACS 806 and store the encrypted data 830 in the DRAM device(s) 818 from the IME block with PACS 806.

In at least one embodiment, the MAC can be calculated on a first encrypted data stored with a second encrypted data as part of the algorithm (e.g., Advanced Encryption Standard (AES)) or separately with a different algorithm. The memory controller 816 can receive the encrypted data 830 and EDC check symbols from the IME block with PACS 806 and store the encrypted data 830 and check symbols in the DRAM device(s) 818. The host-to-unencrypted memory path can bypass the IME block with PACS 806 for all host transactions. The host-to-unencrypted memory path can still pass through the IME block with PACS 806 for generating the check symbols. In at least one embodiment, the encryption can be serialized (e.g., a first time for memory (DRAM) storage and a second time with a second standard for persistent storage. As described herein, the keys can be stored in persistent memory storage. The persistent memory storage can be used to securely store and restore the encrypted contents of the DRAM to a previous state that can be accessed by the host and restore the keys used to decrypt this data.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic-optical disks, read-only memories (ROMs), RAMs, erasable programmable ROMs (EPROMs), EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

Typically, such “fragile” data is delivered sequentially from the data source to each of its destinations. The transfer can include transmitting or delivering the data from the source to a single destination and waiting for an acknowledgment. Once the acknowledgment has been received, the source then commences the delivery of data to the next destination. The time required to complete all the transfers can potentially exceed the lifespan of the delivered data if there are many destinations or there is a delay in reception for one or more transfer acknowledgments. This has traditionally been addressed by introducing multiple timeout/retry timers and complicated scheduling logic to ensure timely completion of all the transfers and identify anomalous behavior.

In at least one embodiment, the situation can be improved by either broadcasting the data to all the destinations at once, like a multi-cast transmission in Ethernet. This can decouple the data delivery and acknowledgment without delaying the delivery of data by a previous destination's delivery acknowledgment. These approaches can provide some following benefits, as well as others. Broadcasting the data to all destinations at once can remove any limit to the number of destinations that can be supported. The control logic can be simplified. For example, there can be a single time to track the lifespan of data and a single register to track delivery acknowledgment reception. In one embodiment, an incomplete delivery is simply indicated by the register not being fully populated by 1's (or 0's if the convention is reversed) at the end of the data timeout period.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

What is claimed is:

1. A memory encryption circuit comprising:
a first cache comprising a first plurality of cache entries, wherein each cache entry of the first plurality of cache entries has a first persistent valid flag and a first data field for plaintext data;
cryptographic circuitry;
control circuitry, wherein the control circuitry is to:
in a power-off process,
cause the cryptographic circuitry to encrypt the plaintext data of one or more cache entries of the first plurality of cache entries having the first persistent valid flag set to obtain ciphertext data for the one or more cache entries; and
store the ciphertext data in a memory system coupled to the memory encryption circuit; and
in a power-on process,
load the ciphertext data from the memory system for the one or more cache entries having the first persistent valid flag set;
cause the cryptographic circuitry to decrypt the ciphertext data to obtain the plaintext data for the one or more cache entries; and
store the plaintext data in the one or more cache entries of the first cache.

2. The memory encryption circuit of claim 1, wherein each cache entry of the first plurality of cache entries further comprises a first modified flag, wherein, in the power-off process, the control circuitry is to cause the cryptographic circuitry to encrypt the plaintext data of the one or more cache entries having the first persistent valid flag and the first modified flag set to obtain the ciphertext data for the one or more cache entries.

3. The memory encryption circuit of claim 1, wherein each cache entry of the first plurality of cache entries further comprises a tag field for tag data associated with the plaintext data.

4. The memory encryption circuit of claim 1, further comprising:
a second cache comprising a second plurality of cache entries, wherein each cache entry of the second plurality of cache entries has a second persistent valid flag and a second data field for metadata associated with the respective plaintext data of the corresponding cache entry of the first plurality of cache entries.

5. The memory encryption circuit of claim 4, wherein the metadata comprises a message authentication code (MAC) of the respective plaintext data of the corresponding cache entry of the first plurality of cache entries.

6. The memory encryption circuit of claim 4, wherein:
each cache entry of the first plurality of cache entries further comprises a first tag field for first tag data associated with the plaintext data; and
each cache entry of the second plurality of cache entries further comprises a second tag field for second tag data associated with the metadata.

7. The memory encryption circuit of claim 1, wherein the control circuitry is to:
in the power-off process, send a first signal to a host system coupled to the memory encryption circuit, the first signal indicating a first status of the power-off process; and
in the power-on process, send a second signal to the host system, the second signal indicating a second status of the power-on process.

8. An in-line memory encryption (IME) circuit comprising:
a first cache;
cryptographic circuitry; and
control circuitry, wherein the control circuitry is to:
store first plaintext data in a first cache entry of the first cache;
set a first valid flag in the first cache entry, wherein the first valid flag is stored in an always-on cell of the first cache;
receive a first indication of a first power event; and
in response to receiving the first indication,
encrypt, using the cryptographic circuitry, the first plaintext data to obtain first ciphertext data; and
store the first ciphertext data in a memory coupled to the IME circuit.

9. The IME circuit of claim 8, wherein the control circuitry is further to:
receive a second indication of a second power event; and
in response to receiving the second indication,
load the first ciphertext data from the memory;
decrypt, using the cryptographic circuitry, the first ciphertext data to obtain the first plaintext data; and
store the first plaintext data in the first cache.

10. The IME circuit of claim 8, further comprising a second cache, wherein the control circuitry is further to:
store first metadata in a first cache entry of the second cache;
set a second valid flag in the first cache entry of the second cache, wherein the first metadata and the second valid flag are stored in always-on cells of the second cache; and
in response to receiving the first indication, store the first metadata in the memory.

11. The IME circuit of claim 10, wherein the control circuitry is further to:
receive a second indication of a second power event; and
in response to receiving the second indication,
load the first ciphertext data and the first metadata from the memory;
decrypt, using the cryptographic circuitry, the first ciphertext data to obtain the first plaintext data;
store the first plaintext data in the first cache; and
store the first metadata in the second cache.

12. The IME circuit of claim 8, wherein the control circuitry is further to:
store a first tag associated with the first plaintext data in the first cache entry, wherein the first tag is stored in always-on cells of the first cache;
receive a second indication of a second power event; and
in response to receiving the second indication,
load, using the first tag, the first ciphertext data from the memory; and
decrypt, using the cryptographic circuitry, the first ciphertext data to obtain the first plaintext data; and
store the first plaintext data in the first cache entry with the first tag stored in the always-on cells of the first cache.

13. The IME circuit of claim 12, further comprising a second cache, wherein the control circuitry is further to:
store first metadata and the first tag in a first cache entry of the second cache;
set a second valid flag in the first cache entry of the second cache, wherein the first metadata, the first tag, and the second valid flag are stored in always-on cells of the second cache; and
in response to receiving the first indication, store the first metadata and the first tag in the memory.

14. A method of operating a memory encryption circuit comprising a first cache having a first plurality of cache entries, the method comprising:
in a power-off process,
encrypting plaintext data of one or more cache entries of the first plurality of cache entries having a first persistent valid flag set to obtain ciphertext data for the one or more cache entries; and
storing the ciphertext data in a memory system coupled to the memory encryption circuit; and
in a power-on process,
loading the ciphertext data from the memory system for the one or more cache entries having the first persistent valid flag set;
decrypting the ciphertext data to obtain the plaintext data for the one or more cache entries; and
storing the plaintext data in the one or more cache entries of the first cache.

15. The method of claim 14, wherein encrypting the plaintext data further comprises encrypting the plaintext data of the one or more cache entries having the first persistent valid flag set and a first modified flag set to obtain the ciphertext data for the one or more cache entries.

16. The method of claim 14, further comprising:
in the power-off process, storing tag data, associated with the plaintext data of one or more cache entries of the first plurality of cache entries having the first persistent valid flag, in the memory system, wherein the tag data is stored in persistent cells of the first cache, wherein, in the power-on process:
loading the ciphertext data from the memory system comprises loading the ciphertext data using the tag data stored in the persistent cells of the first cache; and
storing the plaintext data in the one or more cache entries with the tag data.

17. The method of claim 14, further comprising:
storing, in a second cache, a second persistent valid flag and metadata associated with the respective plaintext data of the corresponding cache entry of the first cache, wherein the second persistent valid flag and metadata are stored in persistent cells of the first cache.

18. The method of claim 17, wherein the metadata comprises a message authentication code (MAC) of the respective plaintext data of the corresponding cache entry of the first plurality of cache entries.

19. The method of claim 14, further comprising:
storing, in the first cache, tag data associated with the plaintext data of the first plurality of cache entries, wherein the tag data is stored in persistent cells of the first cache; and
storing, in a second cache, the tag data, wherein the tag data is stored in persistent cells of the second cache, and wherein:
in the power-off process, storing tag data, associated with the plaintext data of one or more cache entries of the first plurality of cache entries having the first persistent valid flag, in the memory system; and
in the power-on process:
loading the ciphertext data from the memory system comprises loading the ciphertext data using the tag data stored in the persistent cells of the first cache; and
storing the plaintext data in the one or more cache entries with the tag data.

20. The method of claim 14, further comprising:
in the power-off process, sending a first signal to a host system coupled to the memory encryption circuit, the first signal indicating a first status of the power-off process; and
in the power-on process, sending a second signal to the host system, the second signal indicating a second status of the power-on process.
